(19) United States
(12) Patent Application Publication
(10) Pub. No.: US 2026/0336332 A1
(43) Pub. Date: Oct. 29, 2026

(54) TIRE WITH ASYMMETRICAL TREAD WITH REDUCED SHOULDER HEAT GENERATION

(71) Applicant: The Goodyear Tire & Rubber Company, Akron, OH (US)

(72) Inventors: Josh Aaron Phillipson, Brecksville, OH (US); Christopher David Dyrlund, Canton, OH (US); Duane Thomas Delaney, Canton, OH (US); Elizabeth Amelia RogenskiMitchell, Atwater, OH (US); Michael Stefan Skurich, North Canton, OH (US); Christian Jean-Marie Kaes, Schrondweiler (LU)

(21) Appl. No.: 19/698,047

(22) Filed: Jun. 4, 2026

Related U.S. Application Data
(63) Continuation of application No. 17/355,280, filed on Jun. 23, 2021.
(60) Provisional application No. 63/073,262, filed on Sep. 1, 2020.

(51) Int. Cl. B60C 11/03; B60C 1/00

(52) U.S. Cl. CPC B60C 11/0304; B60C 1/0016; B60C 11/0327

(57) ABSTRACT

A tire having a tread, wherein the tread has an outer shoulder region and an inner shoulder region, wherein each shoulder region is formed from a dual layer strip having a first layer formed of a first compound, and a second layer formed of a second compound, wherein the dual layer strip has a strip ratio of % first compound/%second compound, wherein the outer shoulder region has a strip ratio in the range of 70-95% of the first compound/5-30% of the second compound.

### FIELD OF THE INVENTION

The invention relates in general to tire manufacturing, and more particularly to a tire tread and method of forming.

### BACKGROUND OF THE INVENTION

Tire manufacturers have progressed to more complicated designs due to an advance in technology as well as a highly competitive industrial environment. In particular, tire designers seek to use multiple rubber compounds in a tire component such as the tread in order to meet customer demands. Using multiple rubber compounds per tire component can result in a huge number of compounds needed to be on hand for the various tire lines of the manufacturer. For cost and efficiency reasons, tire manufacturers seek to limit the number of compounds available, due to the extensive costs associated with each compound. Each compound typically requires the use of a banbury mixer, which involves expensive capital expenditures. Furthermore, banbury mixers have difficulty mixing up tough or stiff rubber compounds. The compounds generated from the banbury mixers are typically shipped to the tire building plants, thus requiring additional costs for transportation. The shelf life of the compounds is not finite, and if not used within a certain time period, is scrapped.

Thus, it is desired to have an improved method and apparatus which provides independent flow of two or more compounds from a single application head. More particularly, it is desired to be able to make a custom tire tread or tire component using only two tire compounds, which can be used to simulate multiple compounds having a variety of properties. More particularly, it is desired to provide an asymmetric tire tread that has reduced heat generation in the outside shoulder.

### SUMMARY OF THE INVENTION

The invention relates to a tire as set forth herein. Dependent claims refer to various embodiments of the invention.

In one aspect, a tire having a tread is disclosed wherein the tread has a first shoulder region on an axial first side of the tread and a second shoulder region on the axial opposite side of the tread, wherein each shoulder region is formed from a dual layer strip having a first layer formed of a first compound, and a second layer formed of a different second compound, wherein the dual layer strip has a strip ratio of % first compound to % second compound, wherein first shoulder region has a strip ratio in a range of from 70 to 95% of the first compound to a range of from 5 to 30% of the second compound. The first shoulder region is the axially outside shoulder region of the tire when the tire is mounted on a vehicle in accordance with the tire’s specification and the second shoulder region is the axially inside shoulder region of the tire when the tire is mounted on a vehicle in accordance with the tire’s specification.

In an aspect of the invention, the first shoulder region has a strip ratio of 75% to 85%, preferably 80%, of the first compound to 15 to 25 percent, preferably 20%, of the second compound. The second shoulder region has a strip ratio in a range of from 8 to 15% of the first compound to a range of from 92 to 85% of the second compound.

In an aspect of the invention, the first compound is selected for dry traction or has a higher dry traction, preferably an at least 10 percent higher dry trac tion, than the second compound. In another of the invention, the second compound is selected for rolling resistance or has a lower rolling resistance, preferably an at least 10 percent lower rolling resistance, than the first compound.

The first compound has at least 20% higher hysteresis than the second compound, preferably an at least 50% higher hysteresis than the second compound.

n an aspect of the invention, the dual layer strips are overlapped with each other. In an aspect of the invention, the dual layer strips are applied at an angle in the range of from 0 to 60 degrees, for example, 1 to 10 degrees, with respect to the circumferential direction of the tire.

In an aspect of the invention, one or both of the first and second shoulder regions is formed of a first layer having an at least substantially triangular cross-sectional shape and of a second layer having an at least polygonal shape.

In an aspect of the invention, the first tread compound is selected for the desired tread property from the group of: rolling resistance, stiffness, electrical conductivity, thermal conductivity, wet traction, dry traction, and wear. In another aspect of the invention, the second compound is selected from the desired tread property from the group of: rolling resistance, stiffness, electrical conductivity, thermal conductivity, wet traction, dry traction, and wear.

In a preferred aspect of the invention, the first desired tread property is different than the second tread property

### Definitions

Aspect Ratio means the ratio of a tire’s section height to its section width.

Axial and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17º to 27º with respect to the equatorial plane of the tire.

“Bias Ply Tire” means that the reinforcing cords in the carcass ply extend diagonally across the tire from bead-to-bead at about 25-65º angle with respect to the equatorial plane of the tire, the ply cords running at opposite angles in alternate layers.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65º and 90º with respect to the equatorial plane of the tire.

“Radial Ply Tire” means a belted or circumferentially-restricted pneumatic tire in which the ply cords which extend from bead to bead are laid at cord angles between 65º and 90º with respect to the equatorial plane of the tire.

“Sidewall” means a portion of a tire between the tread and the bead.

“Tangent delta”, or "tan delta," is a ratio of the shear loss modulus, also known as G'', to the shear storage modulus (G'). These properties, namely the G', G'' and tan delta, characterize the viscoelastic response of a rubber test sample to a tensile deformation at a fixed frequency and temperature, measured at 100ºC.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a cross-sectional view of an asymmetrical tire tread profile formed of a 40% of a first compound A and 60% of a second compound B;

FIG. 2 is a cross-sectional view of an asymmetrical tire tread formed of an outside shoulder region formed of multiple layers of a dual layer strip, and an inside shoulder region formed of a dual layer strip, wherein the overall ratio of the first compound to the second compound for the entire tread is 40% A/60% B, and the strip ratio of the outside shoulder region is 80%A/20%B, and the strip ratio for the inside shoulder region is 13% A/87% B;

FIG. 3 is a cross-sectional view of a tire tread formed of a dual layer strip, wherein the overall ratio of the first compound to the second compound for the entire tread is 40% compound A/60% compound B, and the strip ratio used to form the tread has a 40%A/60%B ratio;

FIG. 4A is a front perspective view of a dual layer strip, wherein the dual layer strip has a bottom layer formed of 90% of a first compound and a top layer formed of 10% of a second compound;

FIG. 4B is a front perspective view of a dual layer strip having a bottom layer formed of 95% of a first compound and 5% of a second compound;

FIG. 5A is a perspective view of an apparatus for forming a dual strip, while FIG. 5B is a perspective close up cross-sectional view of a nozzle used to form the dual strip; and

FIGS. 6A-6B illustrate alternative cross-sectional views of the dual layer strip geometry.

### DETAILED DESCRIPTION OF THE INVENTION

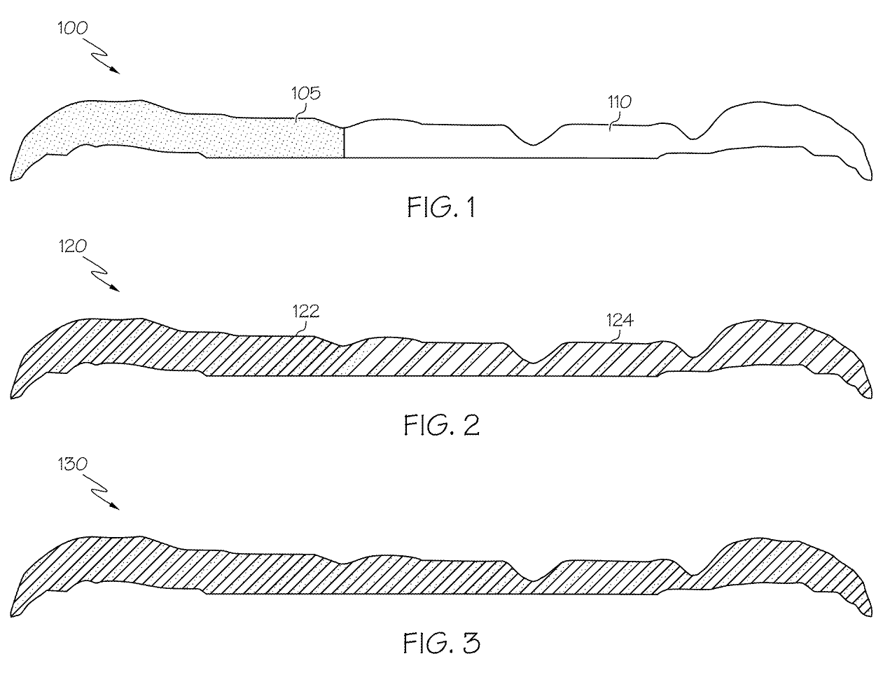

FIG. 1 illustrates a cross-sectional view of a tire tread 100 of the present invention. The tire tread 100 is formed into at least two tread regions, wherein the first tread region 105 is the outside shoulder and is comprised of 100% of a first compound A, wherein the compound A is selected for a first desired property of the tread. In this example, compound A is selected for the property of high traction, and a tread compound having a highly loaded carbon black tread formulation is used for the desired tread characteristics. The second tread region 110 or the inside shoulder region is formed of a second compound B, wherein the second compound B is selected for a desired property of the tread. In this example, the second compound B is selected for low rolling resistance, and low hysteresis, and a highly loaded silica compound is selected, although other low rolling resistance compounds with low hysteresis known to those skilled in the art, are suitable for use. In this example, the overall ratio of the first compound A to the second compound B is 40% A/60% B, although the overall ratio may vary from 20-80% A to 80%-20% compound B.

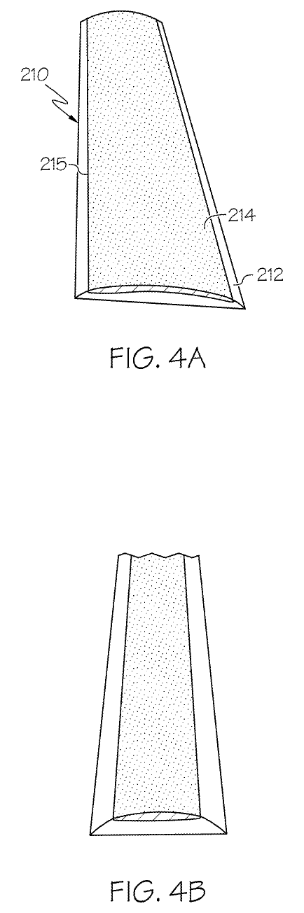

A second embodiment of a tire tread 120 of the present invention is shown in FIG. 2. This tread is also asymmetric and has an outside shoulder region 122 and an inside shoulder region 124. The outside shoulder region 122 is formed of a dual layer strip of a first compound A and a second compound B. The dual layer strip is shown in FIG. 4A and FIG. 4B. The volume ratio of compound A to compound B can be varied, as shown in FIG. 4A and FIG. 4B. In this example, the outside shoulder region 122 is formed of a dual layer strip having a ratio of 80% compound A to 20% compound B. The dual layer strip is formed preferably by spirally winding the strip to form the tread. As shown, the dual layer strip is layed up at an angle that may vary as desired. The inside shoulder region 124 is formed of a dual layer strip, but with a different strip ratio. In this example, the ratio of compound A to compound B is 13% A/87% B. The overall ratio of the tire tread is 40% A and 60% B. Thus, the overall ratio of compound A to compound B is the same in FIG. 1 and FIG. 2. FIG. 2, however, has fine layers of compound A and Compound B in each shoulder region, but the strip ratio is different in each zone.

FIG. 3 illustrates a cross-sectional view of a tire tread 130 of the present invention. In this embodiment, the entire tread is formed of a dual layer strip, wherein the dual layer strip has a strip ratio of 40% A and 60% B, providing an overall tread composition of 40% A and 60%B.

The tire tread profile of FIG. 2 and FIG. 3 result in a lower outside shoulder temperature than the tire tread profile of FIG. 1. In the tire tread profiles of FIG. 2 and FIG. 3, it has been found that the substitution of a portion of the higher hysteresis carbon black dry traction compound with a small portion of the lower hysteresis/lower rolling resistance silica compound in fine layering results in a reduced temperature of the outside shoulder and the lap count handling sensitivity while maintaining the other tire performances. The overall total proportion of the two compounds were maintained, as compared to the overall ratio of FIG. 1.

While the above described tread profiles have described an overall tread composition of 40% A and 60% B, the overall tread composition may vary as desired and are not limited to this example, as well as the strip ratio in each zone. Each zone of the tread can be formed of 100% of compound A or 100% of compound B, or a zone having both compounds A and compound B wherein the compounds A and B are not mixed together. This zone is accomplished by the use of a dual layer strip 210 as shown in FIG. 4A that has two discrete layers of compound A and compound B, and which the ratio of the two compounds in the strip can be varied in real time. Thus, invention provides for a tread formed of multiple zones thus simulating the use of many compounds by varying the volume ratio of compound A to compound B.

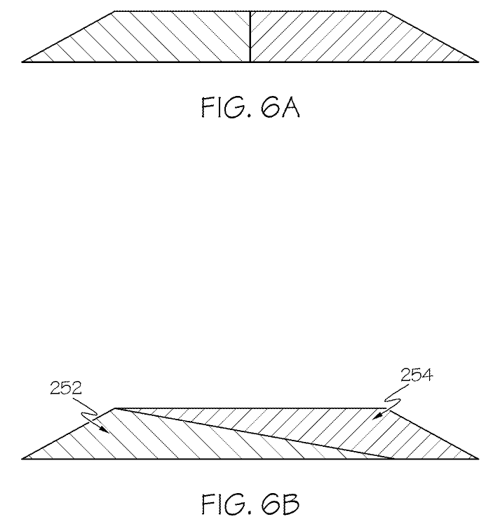

The strip of FIG. 4A and 4B illustrates one embodiment of the strip cross-sectional shape. FIG. 6A illustrates an alternative embodiment of a dual layer strip wherein the layers are side by side. FIG. 6B illustrates a duplex strip configuration having a first layer that has a first triangular cross-sectional shape 252, and a polygon shape 254 forming a second layer.

Multiple compound layering with the dual layer strip with very thin layers enable the tire component to leverage the properties of each compound while minimizing compound to compound interface durability issues because the thin cross sections of each layer are individually exposed to low stress concentration. Dynamically tuning the ratio of the two parent compounds across the component permits fine tuning of the tire zone performance contribution and delivers a previously unachievable performance.

The dual layer strip has a strip thickness in the range of 0 to 10 mm thickness, more preferably in the range of 5-8 mm, and most preferably in the range of 0-3 mm thickness. The overall width of the dual layer strip is in the range of 10-25 mm. The tire tread is formed by spirally winding the dual layer strip onto a tire carcass or a tire building drum. The dual layer strips may be oriented at an angle of zero to 60 degrees. Multiple layers of the dual layer strip may be used to form the tire tread regions such as a rib.

### Dual Strip Forming Apparatus

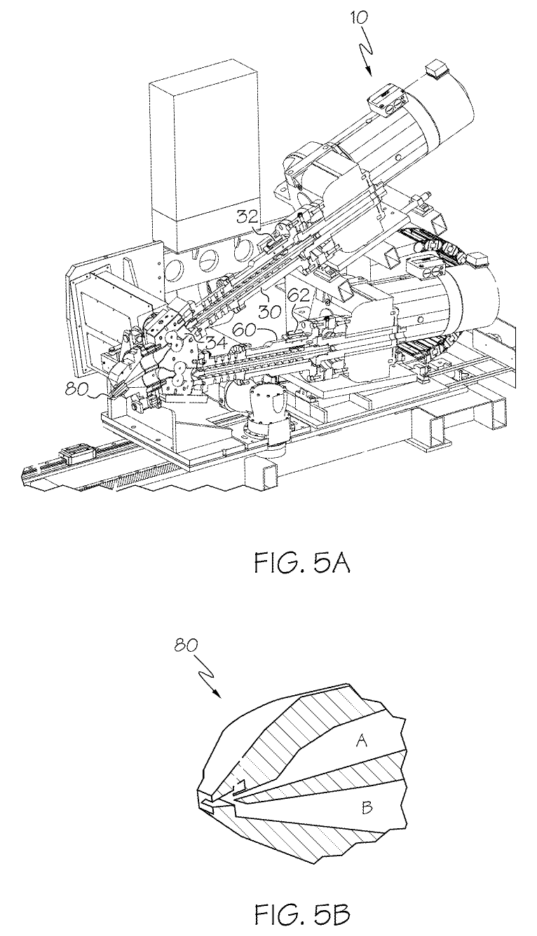

The apparatus used to form the continuous dual layer strip is shown in FIGS. 5A and 5B. The apparatus can form the coextruded strip while instantaneously varying the ratio of the first compound to the second compound. The dual strip forming apparatus 10 includes a first extruder 30 and a second extruder 60, preferably arranged vertically in close proximity. The first extruder 30 has an inlet 32 for receiving a first rubber composition A, while the second extruder 60 has an inlet 62 for receiving a second rubber composition B. Compound A is extruded by the first extruder 60 and then pumped by the first gear pump 62 into a nozzle 80, while at the same time Compound B is extruded by the second extruder 30 and then pumped by the second gear pump 34 into the nozzle 80. The volume ratio of compound A to compound B may be changed by varying the ratio of the speed of gear pump of compound A to the speed of gear pump of compound B. The dual coextruded strip forming apparatus 10 can adjust the speed ratios on the fly, and due to the small residence time of the coextrusion nozzle, the apparatus has a fast response to a change in the compound ratios. This is due to the low volume of the coextrusion zone.

The nozzle 80 forms two discrete layers 212,214 joined together at an interface 215. The nozzle can be configured to provide different cross-sectional configurations of the strip, as shown in FIG. 6A and FIG. 6B.

Variations in the present inventions are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire having a tread, wherein the tread has an outer shoulder region and an inner shoulder region, wherein the outer shoulder region is an axially outside shoulder region of the tire when the tire is mounted on a vehicle and wherein the inner shoulder region is an axially inside region of the tire when the tire is mounted on the vehicle, wherein each shoulder region is formed from a dual layer strip having a first layer formed of a first compound, and a second layer formed of a second compound that is different from the first compound, wherein the outer shoulder region has a strip ratio in a range of from 70% to 95% of the first compound and 5% to 30% of the second compound and wherein the inner shoulder region has a strip ratio of 8% to 15% of the first compound and 85% to 92% of the second compound and wherein the first compound has at least 20% higher hysteresis than the second compound.

2. The tire of claim 1, wherein the first shoulder region has a strip ratio of 75 to 85% of the first compound and 15 to 25% of the second compound.

3. The tire of claim 1, wherein the overall ratio of the first compound to the second compound is 40% of the first compound and 60% of the second compound.

5. The tire of claim 1, wherein the first compound has higher dry traction than the second compound.

6. The tire of claim 1, wherein the second compound has lower rolling resistance than the first compound.

7. The tire of claim 1, wherein the first compound has at least 50% higher hysteresis than the second compound.

8. The tire of claim 1, one of the previous claims wherein the dual layer strips (210) are overlapped with each other.

9. The tire of at least one of the previous claims wherein the dual layer strips are applied at an angle in the range of from 0 to 60 degrees with respect to the circumferential direction of the tire.

10. The tire of claim 1, wherein the dual layer strip has a strip thickness in the range of from 0.5 to 10 mm.
